(19) United States
(12) Patent Application Publication
(10) Pub. No.: US 2013/0318204 A1
(43) Pub. Date: Nov. 28, 2013

(54) THIRD-PARTY ACCESS AND CONTROL OF MEDIA PERIPHERALS ON A MEDIA EXCHANGE NETWORK

(71) Applicant: BROADCOM CORPORATION, IRVINE, CA (US)

(72) Inventors: James D. Bennett, Hroznetin (CZ); Jeyhan Karaoguz, Irvine, CA (US)

(73) Assignee: BROADCOM CORPORATION, IRVINE, CA (US)

(21) Appl. No.: 13/956,256

(22) Filed: Jul. 31, 2013

Related U.S. Application Data
(63) Continuation of application No. 10/672,648, filed on Sep. 26, 2003, now abandoned.
(60) Provisional application No. 60/432,472, filed on Dec. 11, 2002.
(60) Provisional application No. 60/443,894, filed on Jan. 30, 2003.

(51) Int. Cl. G06F 13/14; H04L 29/08

(52) U.S. Cl. CPC G06F 13/14; H04L 67/02
USPC 709/218; 710/33

(57) ABSTRACT

Methods are disclosed for a 3rd party system to indirectly access, control, monitor, and test a media peripheral (MP) device on a media exchange network by establishing a communication link between the 3rd party system and the media peripheral (MP) device via at least one media management system (MMS). A third party may select an operation of a MP device via a MMS over the communication link, causing the MP device to perform the selected operation. The 3rd party may monitor at least one status parameter of a MP device via a MMS over the communication link and respond to the status parameter. As a service, the 3rd party may push digital information (e.g., digital data, digital audio, digital images, digital video, etc.) to a MP device via a MMS over the communication link and bill an account associated with the MP device on the media exchange network.

### CROSS-REFERENCE TO RELATED APPLICATIONS/INCORPORATION BY REFERENCE

The present U.S. Utility Patent Application claims priority pursuant to 35 U.S.C. §120, as a continuation, to the following U.S. Utility Patent Application which is hereby incorporated herein by reference in its entirety and made part of the present U.S. Utility Patent Application for all purposes:

1. U.S. Utility application Ser. No. 10/672,648, entitled “Third-Party Access and Control of Media Peripherals on a Media Exchange Network,” filed Sep. 26, 2003, pending, which claims priority pursuant to 35 U.S.C. §119(e) to the following U.S. Provisional Patent Applications which are hereby incorporated herein by reference in their entirety and made part of the present U.S. Utility Patent Application for all purposes:
a. U.S. Provisional Application Ser. No. 60/432,472, entitled “Personal Inter-Home Media Exchange Network”, filed Dec. 11, 2002, and
b. U.S. Provisional Application Ser. No. 60/443,894, entitled “Personal Access And Control Of Media Peripherals On A Media Exchange Network”, filed Jan. 30, 2003.

In addition, this application makes reference to U.S. patent application Ser. No. 10/657,390, entitled “Personal Inter-Home Media Exchange Network”, filed Sep. 8, 2003, and U.S. patent application Ser. No. 10/660,267, entitled “Personal Access And Control Of Media Peripherals On A Media Exchange Network”, filed Sep. 11, 2003, the complete subject matter of which are hereby incorporated herein by reference, in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Digital media devices may be battery powered, portable or mobile devices that are designed to operate while in motion (“roaming digital media devices”), or may be designed for operation while in a fixed location and usually connected to a power outlet (“stationary digital media devices”). Typical digital media devices, including media capture and player devices such as video and image cameras, audio recorders, and video, audio and image players, are designed for direct user control.

Direct control of such digital media devices occurs manually through buttons, switches and keypads on the digital media device or on an associated remote control device. With direct control, users have access to a wide set of device commands and trick modes, such as power on or off, play, rewind, capture, erase, delete, zoom, rewind, skip, sleep, standby, volume, brightness, modes, scan, etc. Direct access to media (for playback, review, etc.) in typical digital media devices is but one result of direct control.

Many of such digital media devices also use displays, light emitting diodes, and other visual components to assist the user in carrying out direct control. Audible or audio components are also often employed to assist.

Most digital media devices offer no means for indirect control, and, for those that do, the indirect control is very limited and difficult to use. Indirect control is control that is initiated from an independent device that may or may not be operated by a user. Independent devices do not include remote control devices that communicate directly with the digital media device (associated remote control devices).

A personal computer (PC) is an exemplary independent device that is often used to indirectly access media stored on a digital media device via a wired link. The indirect control of such digital media devices involves the: (1) exchange of media meta information, e.g., media file names, sizes, dates, resolution and format; (2) uploading of media to the digital media device; or (3) downloading of media from the digital media device. Through such indirect control, a user is able to extract media for printing, routing, or processing or load media for playback or review. Even so, the overall process for doing so is not easy.

For example, to route images to a friend, a user removes a digital camera from its case and through direct control turns on the power, adjusts settings and captures images. Afterwards, the user through direct control turns off the power and returns the camera to its case. Later, when within range of a PC, the user: (1) removes the digital camera from its case; (2) attaches a cable between the PC and the digital camera; (3) powers up the digital camera using direct control; (4) places the camera in a download mode using direct control; (5) runs a PC application that, using indirect control, copies the image files from the digital camera to the PC via the cable; (6) powers down the digital camera using direct control; (7) removes the cable; (8) places the camera into its case; (9) exits the PC application; (10) establishes an Internet connection; (11) runs an e-mail program on the PC; and (12) creates and sends an e-mail with the image files attached. This process is very tedious and time consuming, and, especially when problems arise, requires a fairly savvy user.

Digital media devices operate pursuant to software or firmware stored in digital media device memory. If, after a user purchases a digital media device, a manufacturer identifies a need to upgrade the software or firmware, the manufacturer may have to recall the digital media device to upgrade and require the user to suffer without. Because the recall process is so costly, if a digital media device does not support, for example, a new compression standard, a user most often is forced to purchase another digital media device that does support the new compression standard in lieu of an upgrade.

If a problem occurs with a digital media device, the user typically has to send the digital media device back to the manufacturer for servicing or purchase a replacement. Many of such problems are merely due to user errors that could be resolved through testing or through user, manufacturer and digital media device interaction. Users often telephone manufacturers for resolution, but, because the manufacturer is limited to the voice link, many user errors go undetected. Moreover, only if the digital media device is returned can the manufacturer determine the nature and solutions to true device functionality problems.

Occasionally, a user may want to determine certain statistics of a digital media device such as, for example, model number, software/firmware version, settings, and capabilities. As a result, the user may have to manually examine the digital media device or read through much of the user's manual of the digital media device. Also, in order to discover a battery charge level or a stored image status, for example, of a digital media device, a user may have to find, unpack, and examine the digital media device.

Many times, a user may quickly grab a digital media device such as, for example, a digital camera, only to discover that the digital camera is not ready to use because the charge of the battery pack is low. A user may have to keep a digital media device plugged into a wall socket while not using the digital media device to ensure that a battery pack of the digital media device is charged.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention may be found in a method to indirectly control at least one media peripheral via a communication network. Such a method may comprise identifying by a first system, at a first location, the at least one media peripheral communicatively coupled to a second system, at a second location, and establishing a communication link between the first system and the at least one media peripheral. The method may also comprise selecting, at the first location, an operation of the at least one media peripheral, requesting performance of the selected operation on the at least one media peripheral, and determining authorization of the performance of the selected operation. In addition, an embodiment of the present invention may comprise performing the selected operation on the at least one media peripheral if the authorization is successful, and not performing the selected operation on the at least one media peripheral if the authorization is not successful.

In an embodiment of the present invention, the at least one media peripheral may comprise one of a digital camera, a personal computer, a digital camcorder, a MP3 player, a mobile multi-media gateway, a home juke-box, and a personal digital assistant. The at least one media peripheral may also comprise a processor running media capture software and/or media player software, and the communication link may be established via at least one of a wired connection and a wireless connection. The operation in an embodiment of the present invention may comprise one of powering the media peripheral on or off, scanning the media peripheral in angle about at least one axis of rotation, transferring stored media from the media peripheral to the first system, and transferring stored media from the first system to the media peripheral. The operation in an embodiment of the present invention may also comprise transferring software from the first system to the media peripheral, transferring status information from the media peripheral to the first system, initiating a test of the media peripheral, and initiating a trick mode of the media peripheral. In addition, the operation may comprise determining whether the media peripheral is within communication range of the second system, putting the media peripheral into a sleep state, and changing a parameter of the media peripheral.

In various embodiments of the present invention, at least one of the first system and the second system may comprise a set-top-box based media processing system, a personal computer based media processing system, and an integrated element of a television based media processing system. The first system may comprise a server of a media provider, a server of a service provider, and a server of a peripheral manufacturer. In various embodiments, establishing the communication link may be initiated by the first system, via a telephone call, and via a web site.

Further aspects of the present invention may be seen in a method to indirectly monitor at least one media peripheral via a communication network. A method in accordance with the present invention may comprise identifying by a first system, at a first location, the at least one media peripheral communicatively coupled to a second system, at a second location, and establishing a communication link between the first system and the at least one media peripheral. The method may also comprise determining authorization for monitoring the at least one media peripheral, and monitoring at least one status parameter of the at least one media peripheral, via the communication link, if the authorization is successful. A method in accordance with the present invention may respond to a state of the at least one status parameter, if the authorization is successful, and may not respond to the state of the at least one status parameter, if the authorization is not successful.

In an embodiment of the present invention, the media peripheral may comprise one of a digital camera, a PC, a digital camcorder, a MP3 player, a mobile multi-media gateway, a home juke-box, and a PDA. The media peripheral may also comprise a processor running media capture software and/or media player software, and the communication link may be established via at least one of a wired connection and a wireless connection. The at least one status parameter may comprise a battery level, an “on/off” indication, an amount of storage used, an amount of storage remaining, a “within range” indication, a software version, a model number, a serial number, and a certificate ID. In various embodiments of the present invention, at least one of the first system and the second system may comprise a set-top-box based media processing system, a personal computer based media processing system, and an integrated element of a television based media processing system. In various embodiments of the present invention, the first system may comprise a server of a media provider, a server of a service provider, and a server of a peripheral manufacturer.

In various embodiments of the present invention, establishing the communication link may be initiated by the first system, via a telephone call, and via a web site. The responding may comprise at least one of powering the media peripheral on or off, initiating a test of the media peripheral, transferring stored media from the media peripheral to the first system, putting the media peripheral into a sleep state, transferring software from the first system to the media peripheral, and changing a parameter of the media peripheral.

Additional aspects of the present invention may be observed in a method to download digital information to a media peripheral device via a communication network. Such a method may comprise identifying by a first system, at a first location, the at least one media peripheral communicatively coupled to a second system, at a second location. The method may also comprise establishing a communication link between the first system and the at least one media peripheral, and determining authorization for downloading digital information to the at least one media peripheral. The method may push digital information from the first system to the media peripheral via the communication link, if the authorization is successful, and not push digital information from the first system to the media peripheral, if the authorization is not successful. An embodiment of the present invention may also comprise billing an account associated with the media peripheral, if the pushing is successful, and not billing an account associated with the media peripheral, if the pushing is not successful. In various embodiments, a method in accordance with the present invention may comprise requesting the digital information from the first system over the communication link, via a telephone call, and via a web site. The digital information may comprise at least one of digital images, digital audio, digital video, software, digital text, and digital data.

Yet other aspects of the present invention may be seen in a method to test a media peripheral device via a communication network. A method in accordance with the present invention may comprise identifying by a first system, at a first location, the at least one media peripheral communicatively coupled to a second system, at a second location. The method may comprise establishing a communication link between the first system and the at least one media peripheral, and determining authorization for testing the at least one media peripheral. In addition, a method in accordance with the present invention may perform a diagnostic test of the media peripheral, from the first system via the communication link, if the authorization is successful, and not perform a diagnostic test of the media peripheral, if the authorization is not successful. An embodiment of the present invention may identify a problem of the media peripheral, from the first system via the communication link, if the diagnostic test is performed, and not identify a problem of the media peripheral, if the diagnostic test is not performed.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an embodiment of a media exchange network supporting 3rd party access, control, and monitoring of media peripheral devices, in accordance with various aspects of the present invention.

FIG. 2A is a flowchart illustrating an embodiment of a method for a 3rd party to indirectly control a media peripheral device on the media exchange network of FIG. 1, in accordance with various aspects of the present invention.

FIG. 2B is a flowchart illustrating an embodiment of a method for a 3rd party to indirectly monitor a media peripheral device on the media exchange network of FIG. 1, in accordance with various aspects of the present invention.

FIG. 2C is a flowchart illustrating an embodiment of a method for pushing digital information to a media peripheral device on the media exchange network of FIG. 1, in accordance with various aspects of the present invention.

FIG. 2D is a flowchart illustrating an embodiment of a method for a 3rd party to indirectly troubleshoot a media peripheral device on the media exchange network of FIG. 1, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a media guide user interface in accordance with an embodiment of the present invention.

FIG. 7 is an exemplary illustration of several instantiations of a media guide user interface of FIG. 4 in accordance with an embodiment of the present invention.

FIG. 8 is an exemplary illustration of a media guide user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

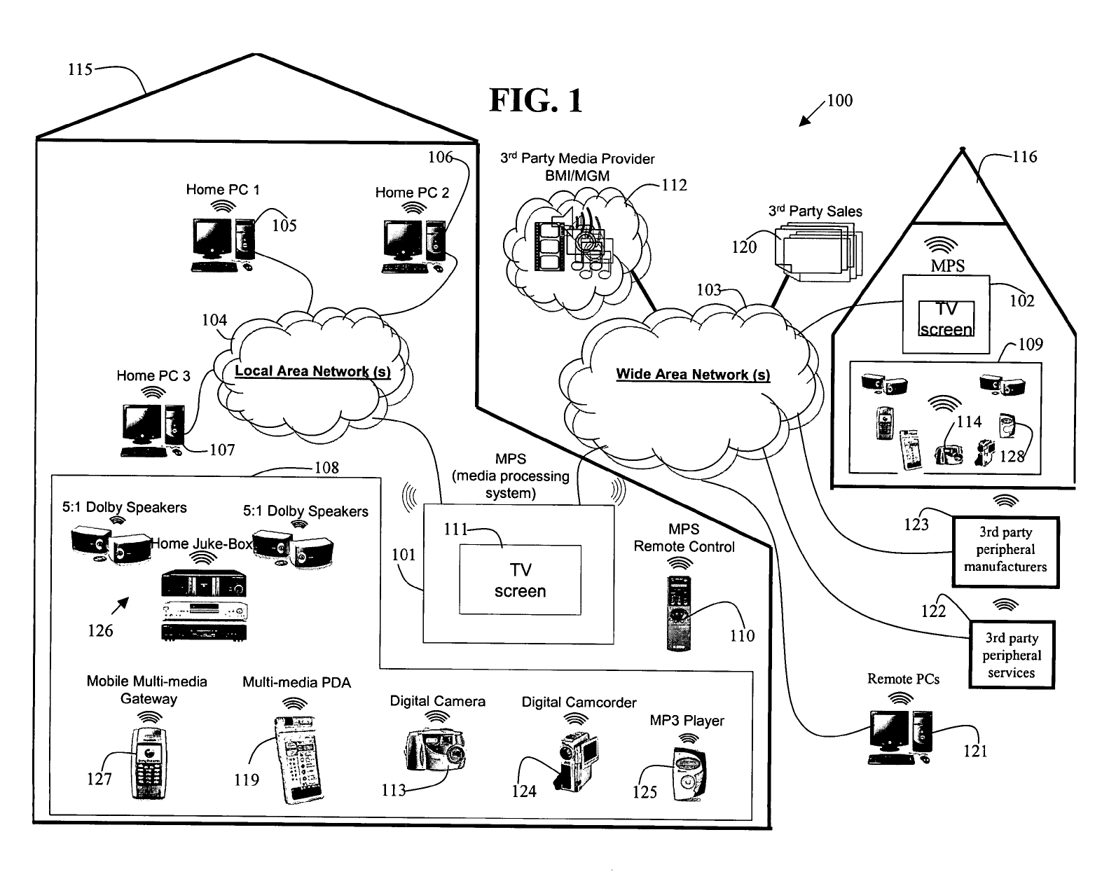

FIG. 1 is a diagram illustrating an embodiment of a media exchange network 100 supporting 3rd party access, control and monitoring of media peripheral devices, in accordance with various aspects of the present invention. Specifically, the media exchange network 100 is a communication network comprising a first MPS (media processing system) 101 located in a home location 115 of the media exchange network 100, a second MPS 102 at a remote location 116, WAN(s) (“Wide Area Network(s)”) 103, and LAN(s) (“Local Area Network(s)”) 104. The MPS 101 may interface wirelessly or via a wired connection to both LAN(s) 104 and WAN(s) 103. Similarly, MPS 102 may interface wirelessly or via a wired connection to WAN(s) 103. Remote location 116 may be, for example, a user's second home, a friend's home, or a family member's home.

The media exchange network 100 also includes several PCs (“personal computers”) 105, 106, and 107 in the home location 115 of the media exchange network 100 that interface wirelessly or via a wired connection to the LAN(s) 104. The PC's may comprise desktop PC's, notebook PC's, PDA's, or any computing device. The media exchange network 100 further comprises a first plurality of media peripheral devices 108 at the home location 115, and a second plurality of media peripheral devices 109 at the remote location 116. The first plurality of media peripheral devices 108 may interface wirelessly or via a wired connection to the MPS 101 in any combination. Similarly, the second plurality of media peripheral devices 109 may interface wirelessly or via a wired connection to the MPS 102 in any combination. As defined herein, a media peripheral device includes a processor running media capture software and/or media player software.

The media peripheral devices (108, 109) may include a digital camera 113, a digital camcorder 124, a MP3 player 125, a home juke-box system 126, a multi-media PDA (personal digital assistant) 119, and a mobile multi-media gateway device 127. The MPS's (101, 102) may include a TV screen 111 for viewing various types of media.

Furthermore, the media exchange network 100 comprises several 3rd party systems including a 3rd party media provider(s) 112, a 3rd party sales provider(s) 120, a remote computer(s) 121, a 3rd party peripheral service(s) 122, and a 3rd party peripheral manufacturer(s) 123 all interfacing wirelessly or via a wired connection to the WAN(s) 103. The 3^{rd} party systems 112, 120, 121, 122, and 123 each comprise a server, in accordance with an embodiment of the present invention.

The LAN(s) 104 may comprise, for example, a home cable infrastructure, an Ethernet infrastructure, an 802.11b wireless infrastructure, or a home PNA (phoneline networking alliance) infrastructure, providing peer-to-peer networking capability within the home location 115.

The WAN(s) 103 may include cable infrastructure, DSL infrastructure, Internet infrastructure, headend infrastructure (e.g., cable headends and satellite headends) or intranet infrastructure in order to provide communications between, for example, the home location 115, the remote location 116, and third party systems 112, 120, 121, 122, 123.

In accordance with various embodiments of the present invention, a MPS may comprise a set-top-box (STB) with a media management system (MMS), a PC with a media management system (MMS), or a TV with a media management system (MMS). A MMS is also known herein as a media exchange software (MES) platform.

A MMS comprises a software platform operating on at least one processor to provide certain functionality including user interface functionality, distributed storage functionality, networking functionality, and to allow 3rd party control and monitoring of media peripheral devices. For example, a MMS may allow 3rd party testing of media peripheral devices, 3rd party status parameter monitoring of media peripheral devices, and 3rd party to MP device routing selection, in accordance with an embodiment of the present invention. Peripheral manufacturer(s) 123 and various other 3rd parties (112, 120, 122) may indirectly access and control the media peripheral devices (108, 109). For example, the 3rd party media provider 112 may poll all registered MP devices on the media exchange network 100 once a week to determine which devices are still within range on the network. An MPS is also known, herein, as a media-box and/or an M-box.

Today, TV is typically only used for media consumption, not to control media peripheral devices without performing media consumption. An MPS may or may not be the beneficiary or initiator of media peripheral device controls. For example, a third party or manufacturer could carry out testing or interrogation of a media peripheral device via an MPS without information consumption or user interaction. In such a case, the MPS is not going to receive or use the information directly.

There are many types of indirect control commands available to manipulate the various media peripheral devices. Each media peripheral device may have particular indirect commands unique to that device or type of device. Many of the indirect commands will find parallels to the available direct commands. Exemplary commands include turning media peripheral devices 108 and/or 109 on and off, initiating play, stop, capture, erase/delete, zoom, rewind, fast forward, scan, list, skip, upload, download, test, poll, sleep, etc.

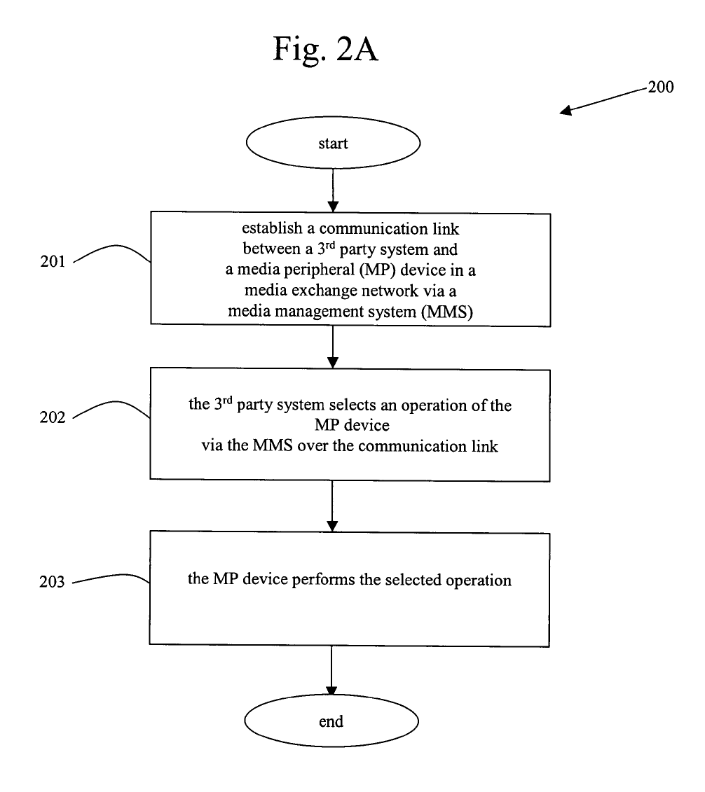

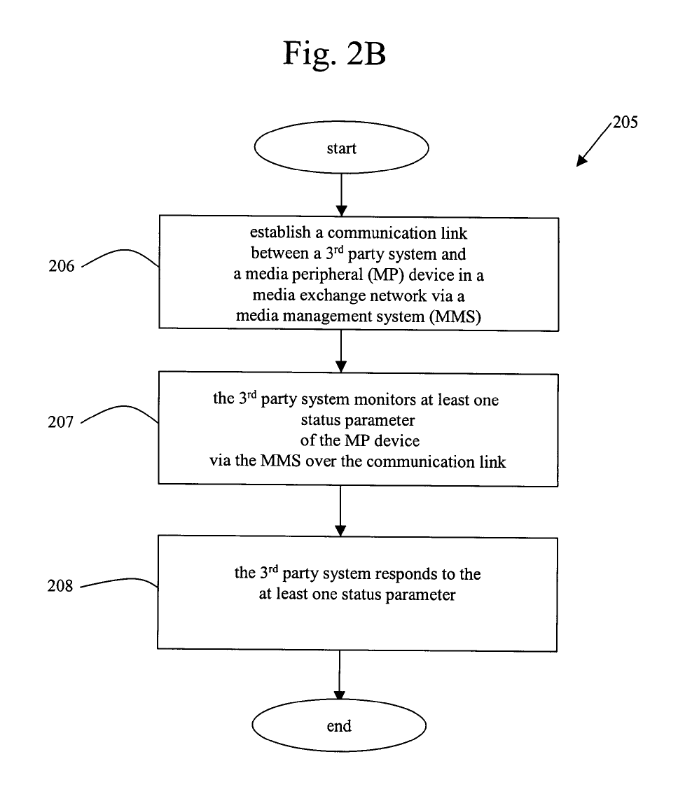

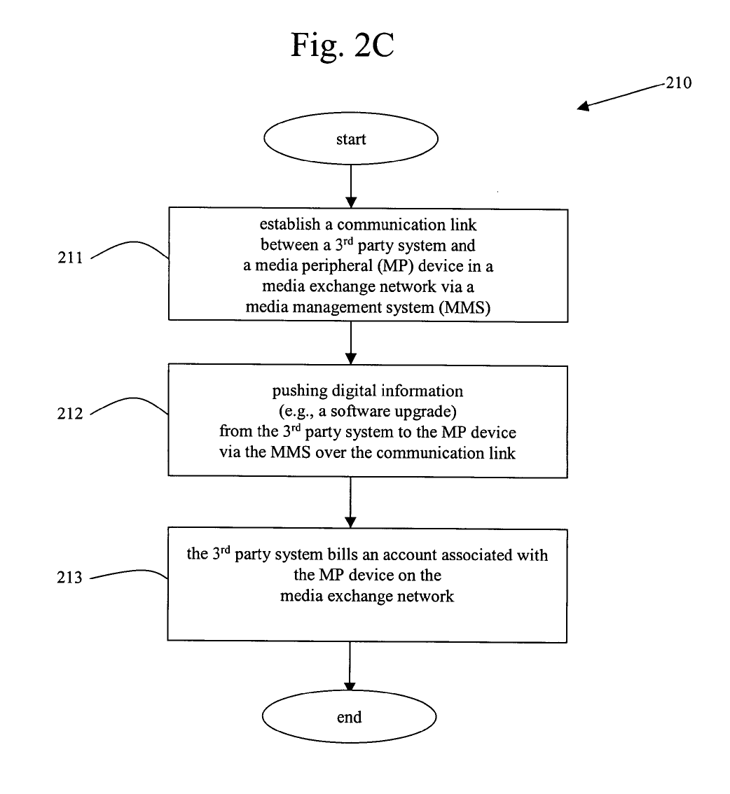

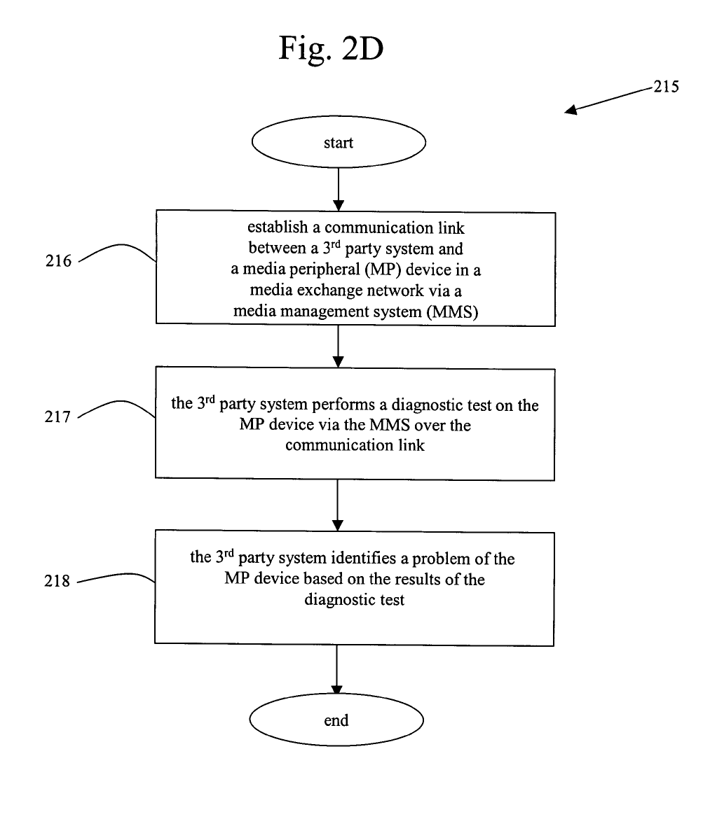

FIG. 2A is a flowchart illustrating an embodiment of a method 200 for a 3rd party to indirectly control a media peripheral device on the media exchange network 100 of FIG. 1, in accordance with various aspects of the present invention. In step 201, a communication link is established between a 3rd party system and a media peripheral (MP) device in a media exchange network via a media management system (MMS). In step 202, the 3rd party system selects an operation of the MP device via the MMS over the communication link. In step 203, the MP device performs the selected operation.

As an example, referring to FIG. 1, the 3rd party media provider 112 (e.g., a server) initiates the establishment of a communication link with the digital camcorder 124 at the home location 115. The communication link is established via a wired connection from the 3rd party media provider 112 to the WAN 103, a wired connection from the WAN 103 to the MPS 101, and a wireless connection from the MPS 101 to the digital camcorder 124. The MPS 101 includes a MMS and acts as an intermediary between the 3rd party media provider 112 and the digital camcorder 124.

The 3rd party media provider 112 then sends a command, via the established communication link, to “power-on” the digital camcorder 124. The digital camcorder 124 responds to the command by powering on. In such a scenario, the 3rd party media provider 112 has routing access to the digital camcorder 124 since the digital camcorder 124 is registered on the media exchange network 100, for example (i.e., registration of a MP device provides routing information to the 3rd party). In accordance with various embodiments of the present invention, a MP device may be registered on a media exchange network in a MPS, a headend, a media exchange server, or on a 3rd party server, for example.

Also, the 3rd party media provider 112 has permission from the user of the digital camcorder 124 and MPS 101 to access the digital camcorder 124 over the media exchange network 100. The 3rd party media provider 112 may be motivated to “power-on” the digital camcorder 112 in order to initiate downloading of a media file to the digital camcorder 124, for example. In accordance with alternative embodiments of the present invention, the establishment of the communication link may be initiated by a user of the MP device via a MMS, via a telephone call, or via a web site.

FIG. 2B is a flowchart illustrating an embodiment of a method 205 for a 3rd party to indirectly monitor a media peripheral device on the media exchange network 100 of FIG. 1, in accordance with various aspects of the present invention. In step 206, a communication link is established between a 3rd party system and a media peripheral (MP) device in a media exchange network via a media management system (MMS). In step 207, the 3rd party system monitors at least one status parameter of the MP device via the MMS over the communication link. In step 208, the 3rd party system responds to the at least one status parameter.

In accordance with an embodiment of the present invention, status parameters may include a battery level, an “on/off” indication, an amount of storage used, and amount of storage remaining, a “within range” indication, a software version, a model number, a serial number, and a certificate ID, for example.

As an example, referring to FIG. 1, the peripheral manufacturer 123 may establish a communication link with and monitor a software status and/or a firmware status of the PDA 119 to determine if the PDA 119 includes a latest software and/or firmware upgrade. The communication link extends from the peripheral manufacturer 123 to the WAN(s) 103 via a wired connection, from the WAN(s) 103 to the MPS 101 via a wired connection, and finally, from the MPS 101 to the PDA 119 via a wireless connection. If the PDA 119 does not include the latest software and/or firmware upgrade, the 3rd party peripheral manufacturer 123 may download the software and/or firmware upgrade to the PDA 119. In accordance with an alternative embodiment of the present invention, the MPS 101 may first give permission to the peripheral manufacturer 123 before downloading commences. A 3rd party system may perform feature interrogation such that the statistics (stats) of a media peripheral device (e.g., camera resolution, version number, model number, serial number, registration information, etc.) may be accessed.

FIG. 2C is a flowchart illustrating an embodiment of a method 210 for pushing digital information to a media peripheral device on the media exchange network 100 of FIG. 1, in accordance with various aspects of the present invention. In step 211, a communication link is established between a 3rd party system and a media peripheral (MP) device in a media exchange network via a media management system (MMS). In step 212, digital information is pushed from the 3rd party system to the MP device via the MMS over the communication link. In step 213, the 3rd party system bills an account associated with the MP device on the media exchange network.

In accordance with an embodiment of the present invention, digital information may include at least one of digital images, digital audio, digital video, software, and digital text, and digital data.

For example, 3rd party media provider(s) 112 may deliver nightly MP3 files to the MP3 player 125 at home location 115. The 3rd party media provider(s) 112 establishes a communication link with the MP3 player 125. The communication link may extend from the 3rd party media provider(s) 112 over a wired connection to the WAN(s) 103, then from the WAN(s) 103 to the MPS 101 via a wireless connection, and then from the MPS 101 to the MP3 player 125 via a wireless connection. After downloading the MP3 files, the 3rd party media provider 112 may then bill an account of the user of the MP3 player 125 which is stored on a server of the 3rd party media provider 112 and may be part of a service plan. In alternative embodiments of the present invention, the billing account may be handled by a media exchange server or a headend on the media exchange network.

As another example, a remote computer(s) 121 may arrange for a 3rd party media provider(s) 112 to deliver and archive media to multi-media gateway 127 at the home location 115 via a web site. Arrangement commands such as “select media source”, “select media destination”, “select media type”, and “select specific media” are communicated from the remote computer(s) 121 to the WAN(s) 103, via a wireless connection using the web site, and then from the WAN(s) 103 to the 3rd party media provider(s) 112 via a wired connection.

Next, the 3rd party media provider(s) 112 establishes a communication link to the multi-media gateway 127 via the MPS 101. The 3rd party media provider(s) 112 commands the MPS 101 and the multi-media gateway 127 to be powered on, commands the MPS 101 to compress the subsequent media that will be sent, and commands the MPS 101 to archive, on the multi-media gateway 127, the resultant compressed media. The commands are communicated from 3rd party media provider(s) 112 to the WAN(s) 103 via a wired connection, and then from the WAN(s) 103 to the MPS 101 via a wired connection, and then from the MPS 101 to the multi-media gateway 127 via a wireless connection. In accordance with various embodiments of the present invention, billing for the delivered media may be to a user account on the media exchange network 100, charged to a credit card, or billed, for example, on a monthly basis to a user at the home location 115.

As a similar example, the MPS 102 at the remote location 116 may arrange for a 3rd party media provider(s) 112 to deliver and archive media to the home PC 105 at the home location 115 using a remote control and TV screen to make the arrangements at the remote location 116. Arrangement commands such as “select media source”, “select media destination”, “select media type”, and “select specific media” are communicated from the MPS 102 to the WAN(s) 103 via a wireless connection, and then from the WAN(s) 103 to the 3rd party media provider(s) 112 via a wired connection.

Next, the 3rd party media provider(s) 112 establishes a communication link with the PC 105 via the MPS 101. The 3rd party media provider(s) 112 then commands the MPS 101 to compress the subsequent media that will be sent, and commands the MPS 101 to archive, on the PC 105, the resultant compressed media. The commands are communicated from the 3rd party media provider(s) 112 to the WAN(s) 103 via a wired connection, and then from the WAN(s) 103 to the MPS 101 via a wired connection, from the MPS 101 to the LAN 104 via a wireless connection, and then from the LAN 104 to the PC 105 via a wired connection.

In accordance with alternative embodiments of the present invention, digital information may be requested to be downloaded from a 3rd party to a media peripheral device via a telephone call or a web site.

FIG. 2D is a flowchart illustrating an embodiment of a method 215 for a 3rd party to indirectly troubleshoot a media peripheral device on the media exchange network 100 of FIG. 1, in accordance with various aspects of the present invention. In step 216, a communication link is established between a 3rd party system and a media peripheral (MP) device in a media exchange network via a media management system (MMS). In step 217, the 3rd party system performs a diagnostic test on the MP device via the MMS over the communication link. In step 218, the 3rd party system identifies a problem of the MP device based on the results of the diagnostic test.

Certain media peripheral commands may be initiated for testing a media peripheral device. For example, a user of the digital camcorder 124 may contact a 3^{rd} party peripheral service(s) 122 via a telephone or via a web site requesting assistance with a problem. In response, a communication link may be established and commands may be initiated by the 3rd party services(s) 122 to digital camcorder 124 to turn on and perform a test of the digital camcorder 124. The commands may be communicated from the 3^{rd} party peripheral service(s) 122 to the WAN(s) 103 via a wired connection, and then from the WAN(s) 103 to the MPS 101 via a wired connection, and finally from the MPS 101 to the digital camcorder 124 via a wireless connection.

For example, a battery charge level of the digital camcorder 124 may be checked, as well as checking other key features. Checking certain key features of a media peripheral device, such as battery charge level, may also be set up to be performed periodically by a 3r4d party service without user initiation. The user may then be alerted, via the TV screen 111, if a problem is found or if action needs to be taken.

As another example, diagnostic software within the digital camcorder 124 may be run upon command from the 3rd party peripheral service(s) 122. Results of the diagnostic test may be transmitted over the established communication link back to the 3rd party peripheral service(s) 122. The 3rd party peripheral service(s) 122 may then identify the problem as a bad optical filter in the digital camcorder 124, for example.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel.

PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

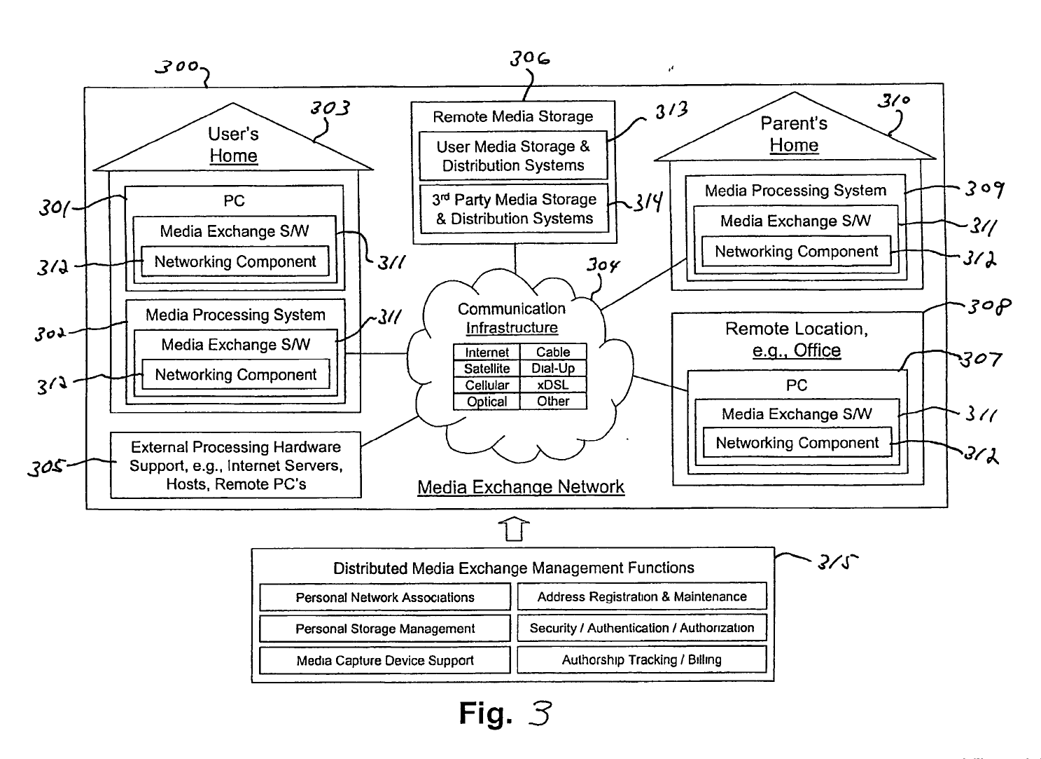

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

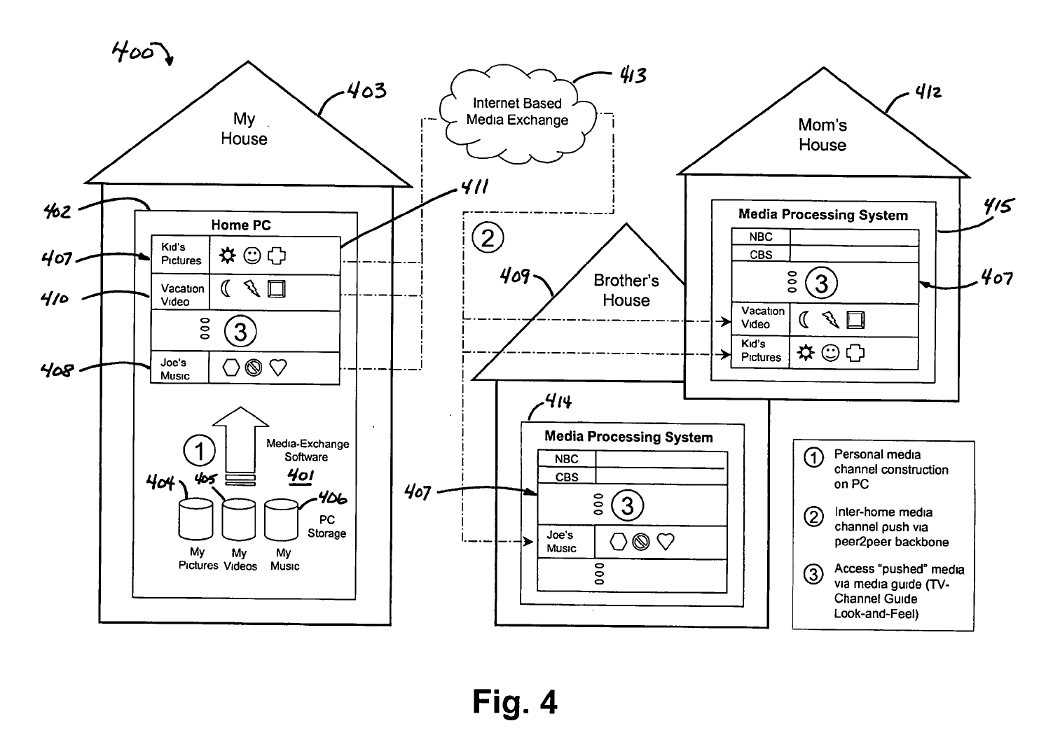

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

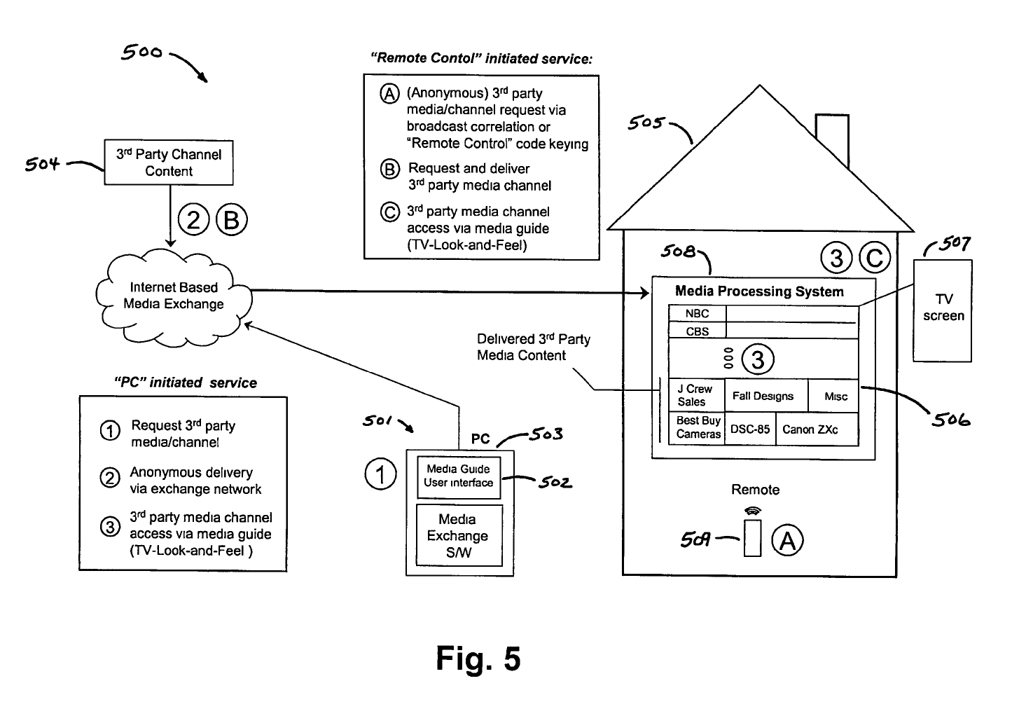

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

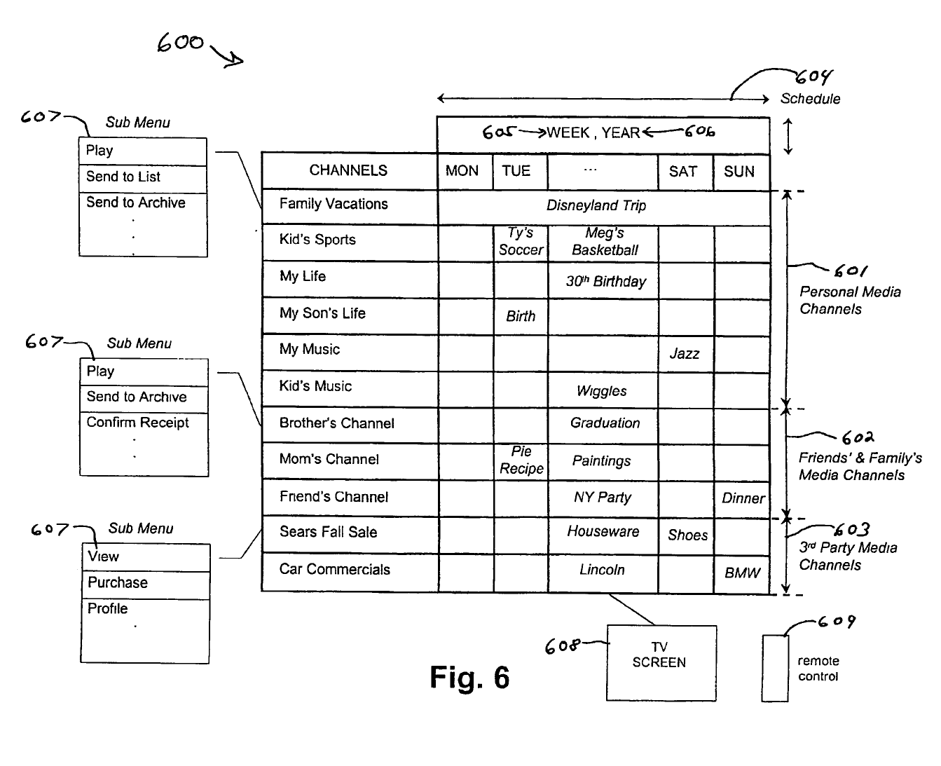

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

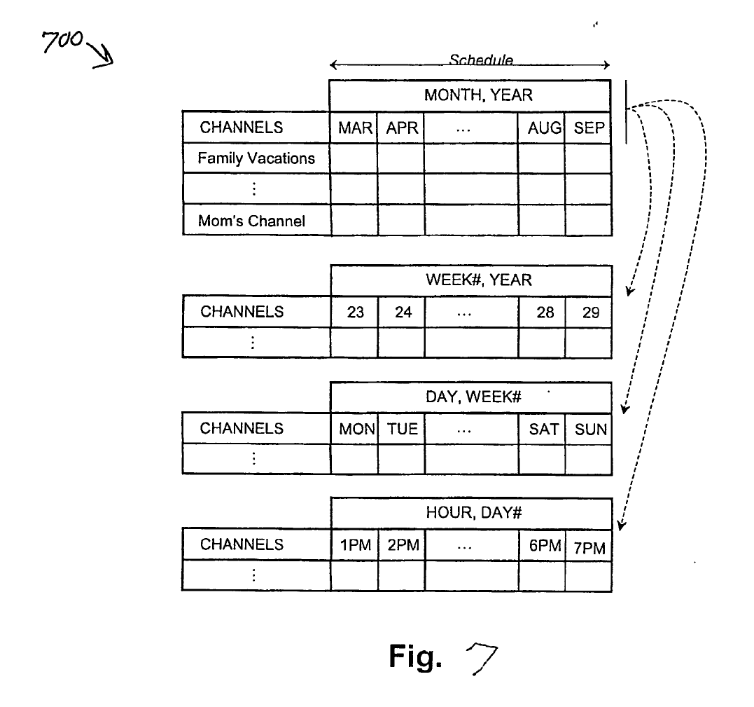

FIG. 7 illustrates possible multiple instantiations of a media guide user interface 700 in accordance with an embodiment of the present invention. The media guide user interface 700 may be viewed with a schedule having formats of, for example, “month, year”, “week #, year”, “day, week #”, or “hour, day”.

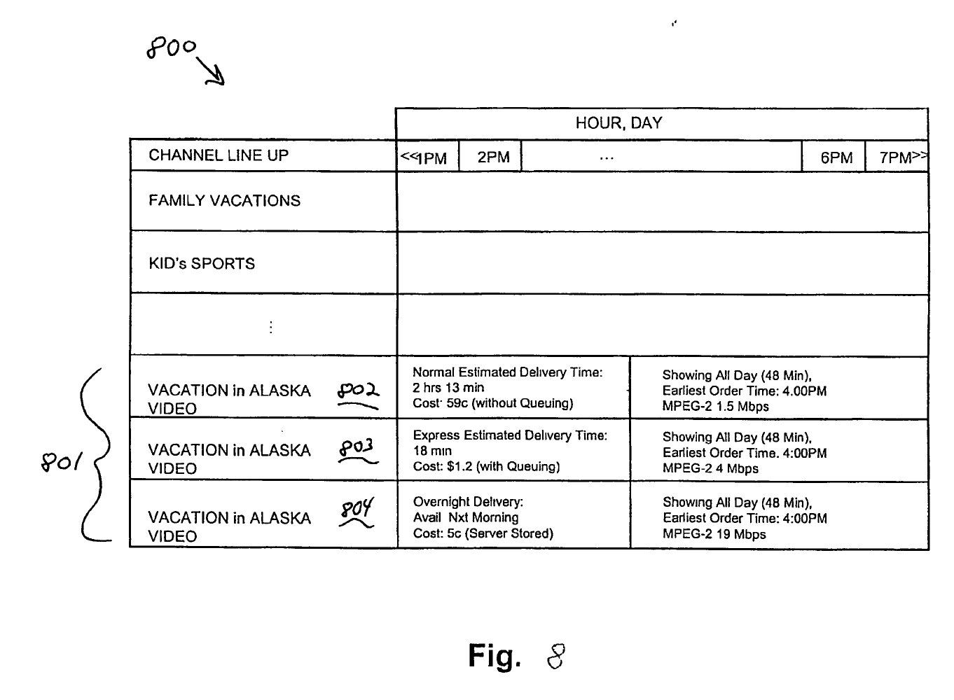

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

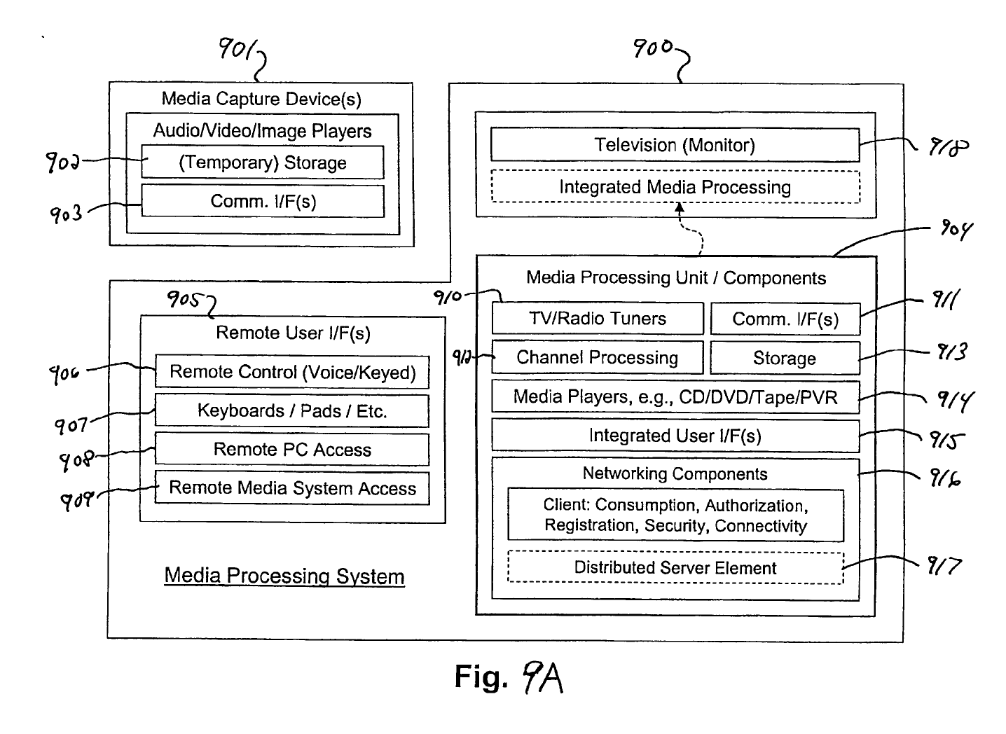

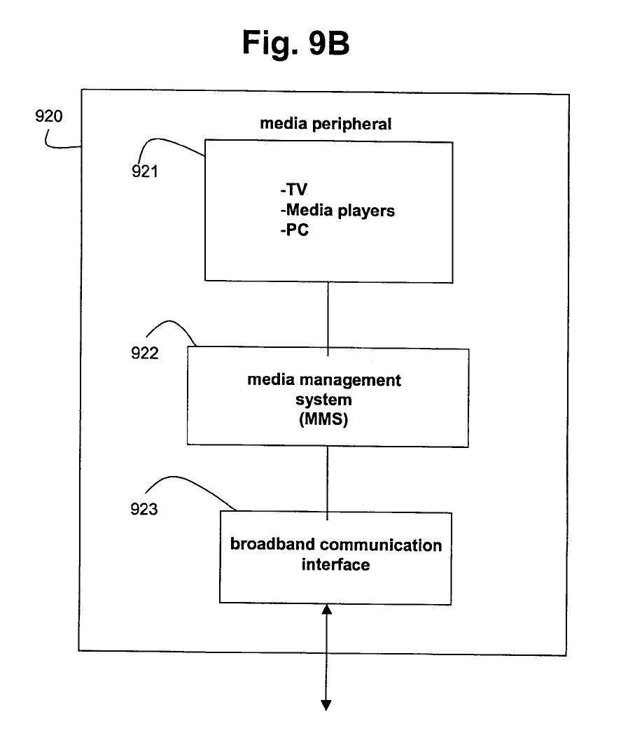

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

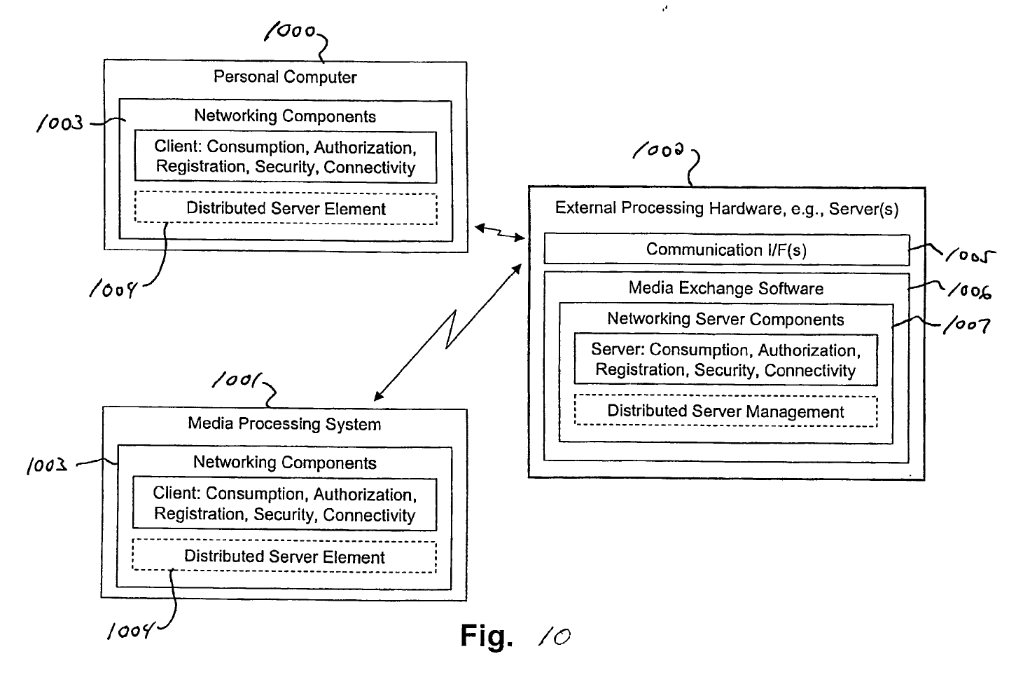

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

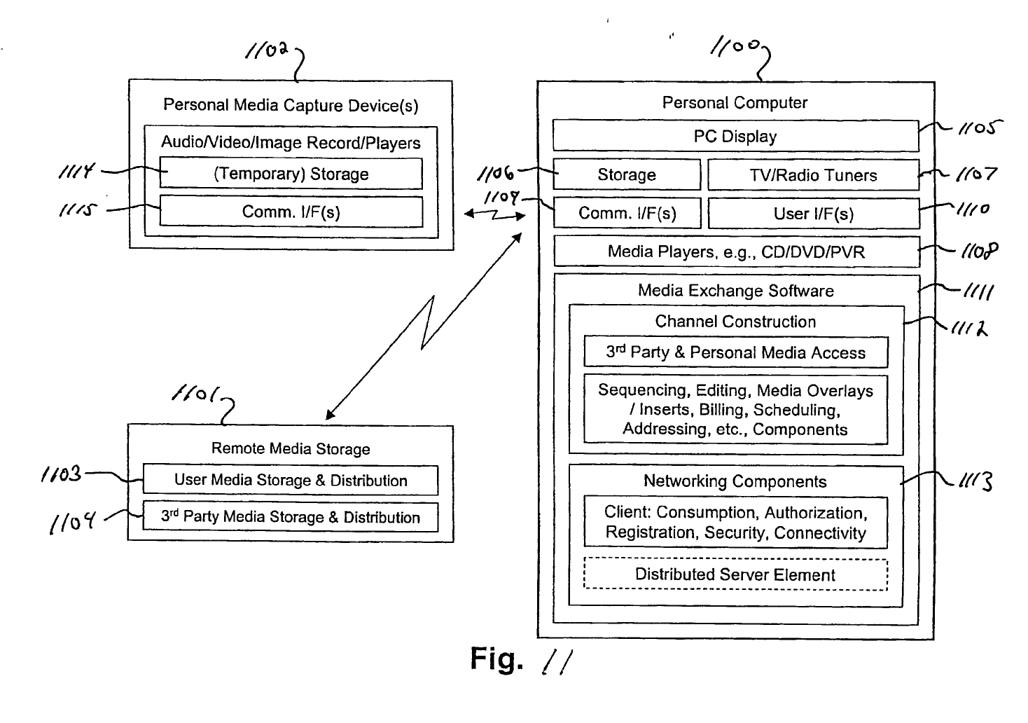

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Various embodiments of the present invention include methods for a 3rd party to indirectly access, control, monitor, and test media peripheral devices on a media exchange network by establishing a communication link between the 3rd party and the media peripheral (MP) devices via at least one media management system (MMS).

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method to communicate personal media comprising:
identifying by a first system at least one media peripheral of a second system;
establishing a peer-to-peer connection between the first system and the identified at least one media peripheral of the second system;
selecting by the first system an indirect control operation of the at least one media peripheral of the second system;
performing the selected indirect control operation on the at least one media peripheral of the second system; wherein the indirect control operation at least powers on the media peripheral of the second system; and
pushing personal media between the first system and the at least one powered on media peripheral of the second system via the peer-to-peer connection.

2. The method according to claim 1, further comprising determining authorization by the first system for performing the indirect control operation on the at least one media peripheral.

3. The method according to claim 1, wherein the peer-to-peer connection is initiated by the first system via a telephone connection or by interaction with a web site.

4. The method according to claim 1, wherein the at least one media peripheral comprises one or more of: a digital camera, a personal computer, a digital camcorder, a MP3 player, a mobile multi-media gateway, a home juke-box, and a personal digital assistant.

5. The method according to claim 1, wherein the at least one media peripheral comprises one or more of a processor running media capture software and media player software.

6. The method according to claim 1, wherein the first system comprises one or more of: a server of a media provider, a server of a service provider and a server of a peripheral manufacturer.

7. A method to indirectly control at least one media peripheral via a communications network, comprising:
identifying by a first system at a first location the at least one media peripheral of a second system at a second location;
establishing a communications network between the first system and the identified at least one media peripheral, wherein the communications network comprises peer-to-peer connections;
selecting by the first system at the first location, an indirect control operation of the at least one media peripheral of the second system at the second location;
performing the indirect control operation on the at least one media peripheral of the second system at the second location; wherein the indirect control operation powers on the media peripheral of the second system at the second location; and
pushing personal media between the first system and the at least one powered on media peripheral of the second system at the second location via the peer-to-peer connections.

8. The method according to claim 7, further comprising determining authorization by the first system at the first location for performing the indirect control operation on the at least one media peripheral.

9. The method according to claim 7, wherein the peer-to-peer network is initiated by the first system at the first location via a telephone call or a web site.

10. The method according to claim 7, wherein the at least one media peripheral comprises one or more of: a digital camera, a personal computer, a digital camcorder, a MP3 player, a mobile multi-media gateway, a home juke-box and a personal digital assistant.

11. The method according to claim 7, wherein the at least one media peripheral comprises one or more of a processor running media capture software and media player software.

12. The method according to claim 7, wherein the first system at the first location comprises one or more of: a server of a media provider, a server of a service provider and a server of a peripheral manufacturer.

13. A third party media exchange system comprising:
an internet-based media exchange network comprising third party media channels;
at least one media peripheral communicatively coupled to the internet-based media exchange network;
a media processing system communicatively coupled to the internet-based media exchange network; and
wherein the media processing system includes a media guide user interface for accessing the third party media content.

14. The third party media exchange system according to claim 13, wherein the third party media channel includes third party media content.

15. The third party media exchange system according to claim 13, wherein the internet-based media exchange network is further configured to receive requests for delivery of the third party media channels, by the at least one media peripheral, to the media processing system.

16. The third party media exchange system according to claim 13, wherein the internet-based media exchange network is further configured to receive requests for delivery of third party media channels, by the media processing system, to the at least one media peripheral.

17. The third party media exchange system according to claim 13, wherein the at least one media peripheral further includes a media guide user interface for accessing third party media channels.

18. The third party media exchange system according to claim 13, wherein the at least one media peripheral comprises one or more of a processor running media capture software and media player software.

19. The third party media exchange system according to claim 13, wherein the at least one media peripheral comprises one of: a digital camera, a personal computer, a digital camcorder, a MP3 player, a mobile multi-media gateway, a home juke-box, and a personal digital assistant.

20. The third party media exchange system according to claim 13, wherein the at least one media peripheral comprises one or more of a processor running media capture software and media player software.
